(19) United States
(12) Patent Application Publication
(10) Pub. No.: US 2013/0058609 A1
(43) Pub. Date: Mar. 7, 2013

(54) ATTENUATED SPLITTER MODULE FOR LOW COUNT OUTPUT CHANNELS AND RELATED ASSEMBLIES AND METHODS

(71) Applicant: Elli Makrides-Saravanos, Highland Village, TX (US)

(72) Inventor: Elli Makrides-Saravanos, Highland Village, TX (US)

(21) Appl. No.: 13/562,433

(22) Filed: Jul. 31, 2012

Related U.S. Application Data
(60) Provisional application No. 61/530,687, filed on Sep. 2, 2011.

(51) Int. Cl. G02B 6/26; G02B 6/02

(52) U.S. Cl. 385/38; 264/1.24

(57) ABSTRACT

A splitter module, comprising an enclosure and a splitter device with one or more splitter legs mounted in the enclosure. Each splitter leg has an optical fiber therein extends for a certain length from the splitter. At least one of the splitter legs, and, thereby, the optical fiber, is cut. The cut may be at an angle to the longitudinal axis of optical fiber. The angle may be about 45 degrees. The coating may be stripped off such that the cut end of the optical glass fiber of the at least one output leg is exposed a certain distance. The cut end of the optical glass fiber positions in the interior of the enclosure. A glass-index-matching material, at least partially fills the interior of the enclosure such that the cut end of the optical fiber is embedded in the glass-index-matching material.

### RELATED APPLICATIONS

This application claims the benefit of priority under 35 U.S.C. §119 of U.S. Provisional Application Ser. No. 61/530,687 filed on Sep. 2, 2011 the content of which is relied upon and incorporated herein by reference in its entirety.

### BACKGROUND

1. Field of the Disclosure

The technology of the disclosure relates to splitter modules and related assemblies and methods for attenuating the optical signals in unused splitter legs.

2. Technical Background

Optical splitter devices are installed inside splitter modules for use in FOH cabinets and closures. The splitter modules are generally big in volume due to the large number of pigtailed cables that exit from the module housing. The volume of the splitter module is not a concern in FTTH applications for neighborhoods and subdivisions where larger cabinets are installed in outdoor spaces.

Multi-dwelling units and high rise building applications with architectural space restrictions cannot accommodate the installation of large cabinets. Smaller closures and miniature cabinets are installed to service customers in these buildings. For this purpose, smaller splitter modules with fewer pigtails are more desirable. Devices with fewer channels can be utilized to achieve more compact splitter modules that can easily fit inside the respective cabinets and closures. In addition, the distribution panels of these cabinets and closures have limited numbers of adapters (need for fewer active channels in the splitter module). However, the insertion losses of the splitter modules may be such that the transmitter power is too high for the network. To be compatible with the network architecture, the signal in these devices needs to be attenuated further.

External devices are available to attenuate the signal and can be connected or spliced to the splitter devices. However, for very small splitter modules, it is not feasible to install any additional device inside the module housing. In addition, the cost of the splitter module will be increased by the cost of the attenuator. Moreover, the reliability of the attenuated splitter module will be affected by the additional attenuating device.

### SUMMARY OF THE DETAILED DESCRIPTION

Embodiments disclosed herein include a splitter module, comprising an enclosure and a splitter with one or more splitter legs mounted in the enclosure. Each splitter leg has a first optical fiber therein and extends for a certain length from the splitter. The length may be up to at least about 70 mm or longer. At least one of the splitter legs, and, thereby, the first optical fiber, is cut. The cut may be at an angle to the longitudinal axis of the first optical fiber. The angle may be about 45 degrees. The coating may be stripped off such that the cut end of the glass fiber of the first optical fiber is exposed a certain distance. The distance may be up to at least about 5 mm or longer. The cut end of the glass fiber of the first optical fiber positions in the interior of the enclosure. A glass-index-matching material, as non-limiting examples, silicone, epoxy and polyurethane, at least partially fills the interior of the enclosure such that the cut end of the first optical fiber is embedded in the glass-index-matching material. The at least one splitter leg may be a plurality of splitter legs with ones of the plurality of splitter legs including one of a first optical fiber and a second optical fiber. The second optical fiber may be a channel count optical fiber that exits the splitter module. Additionally or alternatively, the cut end of the first optical fiber may be terminated in a bead of glass-index-matching material.

Embodiments also include a method of attenuating the optical signal in splitter output optical fibers. The method, comprising, disposing a splitter in a splitter module enclosure, routing at least one splitter leg having a first optical fiber from the splitter in the splitter module, cutting the first optical fiber such that the cut end positions with the enclosure; and at least partially filling the enclosure with a glass-index-matching material, as non-limiting examples, silicone, epoxy and polyurethane, such that the cut end is embedded in the glass-index-matching material. The cut end may form about 45 degree angle with a longitudinal axis of the first optical fiber. The method may include extending the first optical fiber such that the first optical fiber extends a length of up to at least 70 mm or more from the splitter to the cut end. The method may further include stripping a coating from the first optical fiber a distance of up to at least 5 mm or more from the cut end. At least one splitter leg may be a plurality of splitter legs, with ones of the plurality of splitter legs having one of a first optical fiber and a second optical fiber. The second optical fiber may route in the splitter module enclosure and be embedded in glass-index-matching. The second optical fiber may be a channel count optical fiber and exits the splitter module. The method may further include disposing a second splitter in the splitter module enclosure. The second splitter module may have a plurality of splitter legs, with ones of the plurality of splitter legs having one of a first optical fiber and a second optical fiber

Additional features and advantages will be set forth in the detailed description which follows, and in part will be readily apparent to those skilled in the art from that description or recognized by practicing the embodiments as described herein, including the detailed description that follows, the claims, as well as the appended drawings.

It is to be understood that both the foregoing general description and the following detailed description present embodiments, and are intended to provide an overview or framework for understanding the nature and character of the disclosure. The accompanying drawings are included to provide a further understanding, and are incorporated into and constitute a part of this specification. The drawings illustrate various embodiments, and together with the description serve to explain the principles and operation of the concepts disclosed.

### BRIEF DESCRIPTION OF THE FIGURES

FIG. 1A illustrates detail view of the end of a coated optical fiber in air wherein the glass fiber terminates at the same point as the optical fiber coating forming a glass to air boundary;

FIG. 1B illustrates another detail view of the end of a coated optical fibers in air wherein the optical fiber coating is stripped back exposing a portion of the glass fiber forming a glass to air boundary;

FIG. 1C illustrates detail view of the end of coated optical fiber in a glass-index-matching material forming a glass to glass-index-matching material boundary;

FIG. 2A illustrates a detail view of the end of a coated optical fiber with an entrapped air bubbles in the glass-index-matching material;

FIG. 2B illustrates a detail view of an exemplary embodiment of an optical fiber with the fiber coating stripped off a certain distance so that the glass fiber extends past the end of the coating;

FIG. 2C illustrates a detail view of an exemplary embodiment of an optical fiber with the end of the optical fiber terminated with an epoxy bead;

FIG. 3 is a detail view of an exemplary embodiment of an optical fiber with the end of optical fibers cut at a 45 degree angle showing the internal reflection;

FIG. 4 is a detail view of the an exemplary embodiment of an attenuated 2−1×4 splitter module showing the interior of the module and the cut ends of the optical fibers of certain of the output legs;

FIG. 5 is a partial detail view of the interior of an attenuated splitter module of FIG. 4 showing the cut end of several optical fibers with the fiber coating stripped off for the last few millimeters.

### DETAILED DESCRIPTION

Reference will now be made in detail to the embodiments, examples of which are illustrated in the accompanying drawings, in which some, but not all embodiments are shown. Indeed, the concepts may be embodied in many different forms and should not be construed as limiting herein; rather, these embodiments are provided so that this disclosure will satisfy applicable legal requirements. Whenever possible, like reference numbers will be used to refer to like components or parts.

One of the most commonly used devices for fiber-to-the-home (FTTH) applications are the 1×32 and 1×16 splitter modules. The network architecture is designed around the power that is transmitted by these devices with insertion loss of 15 dB and 12 dB, respectively. However, not all of the output optical fibers may be needed for the network. Using 1×4 and 1×8 splitter devices is possible. The insertion losses of 1×4 and 1×8 splitter devices may be 6 dB and 9 dB, respectively, resulting in transmitter power that is too high for the network. As such, the optical signal in these splitter devices needs to be attenuated further.

Embodiments disclosed herein include an optical splitter module, comprising an enclosure and a splitter module device mounted in the enclosure. At least one of the output legs from the splitter device is cut such that the end of the at least one output leg positions in the enclosure. A glass-index-matching material, a material having an index of refraction equal to that of glass, as non-limiting examples, silicone, epoxy or polyurethane, at least partially fills the enclosure such that the end of the at least one output leg is embedded in the glass-index-matching material. The splitter modules may include high channel-count splitter devices, as non-limiting examples, 1×32 or 1×16, where the attenuation is compatible with the network architecture. For a splitter module with a smaller count of active channels using the same devices, only the required number of optical fibers may be terminated with connectors. The remaining unused optical fibers, may be cut, as a non-limiting example, with scissors for ease of manufacturing. In this process the glass of the optical fiber may be generally crushed in an irregular endface.

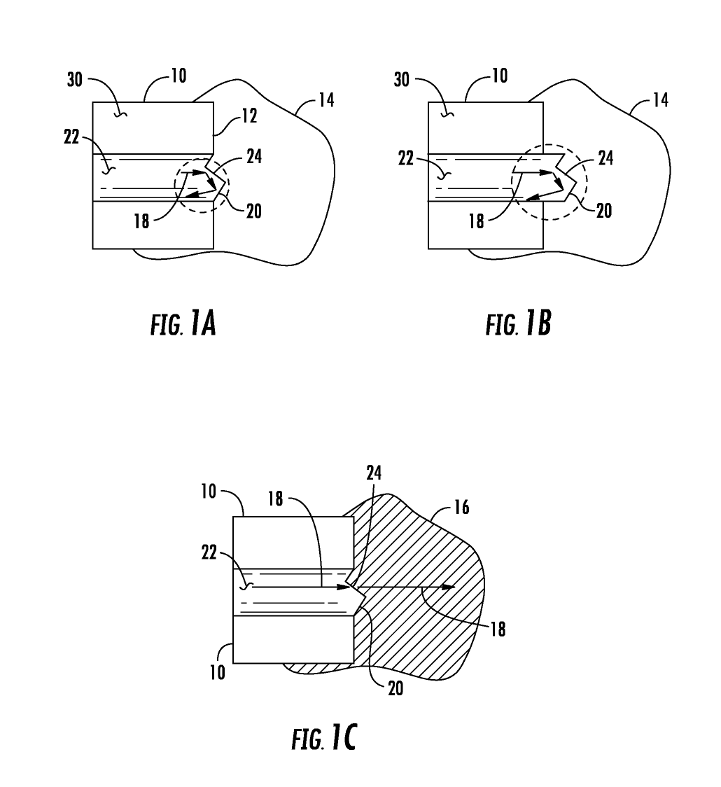

In this regard, FIGS. 1A, 1B and 1C illustrate detailed views of coated optical fibers 10 with the ends 12 of coated optical fibers 10 in air 14 and in glass-index-matching material 16, as non-limiting examples, silicone, epoxy or polyurethane, having an index of refraction equal to that of glass. FIG. 1A illustrates a coated optical fiber 12 cut in a way so that the glass fiber 22 terminates in air 14 at the same point as the optical fiber 12 coating 30. FIG. 1B illustrates a cut coated optical fiber 12 with the coating 30 stripped back so that the glass fiber 22 extends past the coating 30 and, therefore, is exposed. When the signal (or light wave) 18 crosses a boundary 20 between the glass fiber 22 and air 14 at an angle, the irregular-shaped interface 24 is capable of causing an internal reflection of part of the signal 18. This is so when the light travels from a medium of a higher refractive index such as glass 22 (n_{glass}=1.45) to air 14 that has a lower refractive index (nₐᵢᵣ=1.00). FIG. 1C illustrates a coated optical fiber 12 cut in a way so that the glass fiber 22 terminates at the same point as the optical fiber 12 coating 30 with the cut end embedded in glass-index-matching material 16. Embedding the irregular-shaped interface 24 of the cut end of the glass fiber 22 in the glass-index-matching material 16, removes the likelihood of internal reflection of the signal 18 since the refractive index of the glass-index-matching material 16 matches that of fused silica and essentially removes the effect of the interfacial boundary between the two materials.

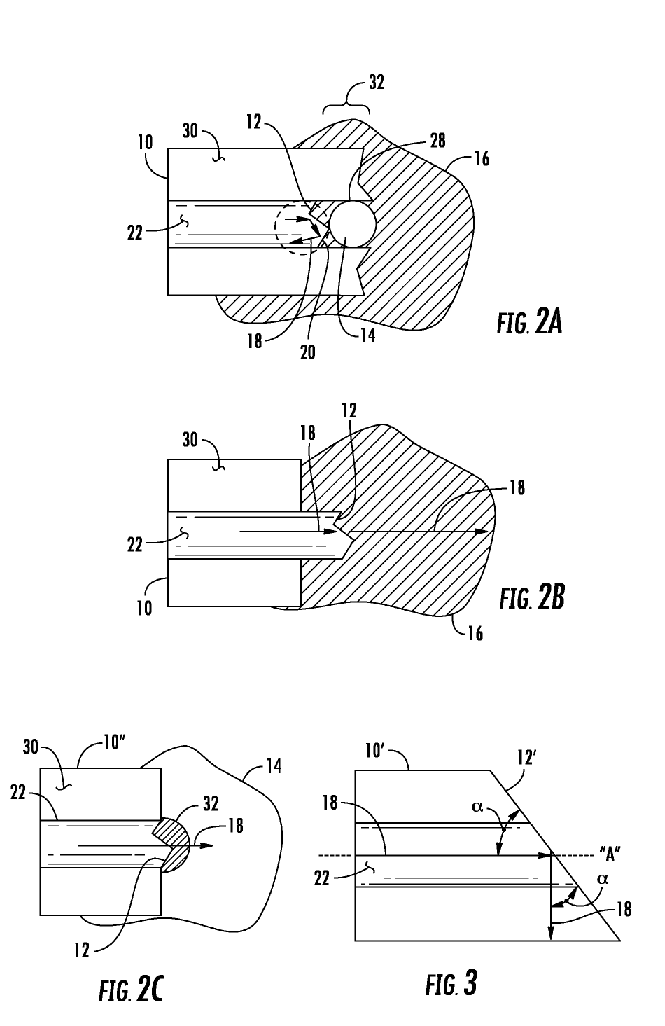

FIGS. 2A, 2B, and 2C illustrate detailed views of the end 12 of the coated optical fiber 10 and the propagation of the optical signal 18. The cut glass fibers 22 may be recessed inside acrylic fiber coating 30. As illustrated in FIG. 2A, the cavity space 32 between the glass 22 and the extended fiber coating 30 may be a site of air 14 entrapment and bubble 28 formation. When an air bubble 28 is formed in the cavity space 32, the glass fiber 10 end 12 is bounded by air 14 instead of glass-index-matching material 16 and internal reflection is again possible according to the ratio of the refractive indices of air 14 and glass 22 (instead of glass-index-matching material and glass-n_{air<}n_{glass}).

To remove this mode of failure, the optical fiber 10 may be cut long enough such that the last few millimeters of the coating 30 of the optical fiber 10 is stripped off exposing the glass fiber 22 for a distance past the fiber coating 28. In this way, the glass fiber 22 without the fiber coating 28 may be fully embedded in the glass-index-matching material 16, as illustrated in FIG. 2B. This removes the possibility of an air bubble 28 being trapped in front of the optical fiber 10 and in the way of the optical signal 18. Optionally, the exposed glass fiber may be cleaned with a solvent such as non-limiting examples, alcohol or acetone, thereby reducing the chance of an air bubble adhering to the glass due to surface tension.

Referring now to FIG. 2C, an exemplary embodiment is illustrated. In FIG. 2C, the end of the at least one cut optical fiber 10″ is terminated with a bead of a glass-index-matching material 32 as a non-limiting example, a UV epoxy with a refractive index that matches that of the glass. The bead 32 will allow the signal 18 to propagate through the bead 32 rather than reflect internally at the glass end. Applying the bead 32 may be a time consuming manufacturing process when it is applied to each individual cut optical fiber 10″. Additionally, a glass-index-matching material such as silicone is more durable and lasts longer in high power applications than the UV epoxy. Moreover, and although not shown in FIG. 2C, an air bubble 28 may be trapped in front of the optical fiber 10 and in the way of the optical signal 18 as described above with respect to FIG. 2A.

FIG. 3 is a detailed view of a coated optical fiber 10′ with its end 12′ cut at a certain angle “a” from the longitudinal axis “A” of the optical fiber 10′ and showing the internal reflection of the optical signal 18. In FIG. 3, “a” is shown as a 45 degree angle. At angle “α” of 45 degrees, the optical signal is internally reflected into the cladding of the optical fiber 10′ and not back along the optical fiber 10′. Although “a” may be any suitable angle to provide the appropriate internal reflection of the optical signal 18, if “a” is not exactly at 45 degrees, some signal 18 may be transmitted out of the optical fiber 10′. In such a case, depending on the refractive index of the medium in which the optical fiber 10′ is positioned, some internal reflection of the optical signal 18 back along the optical fiber 10′ is possible. Additionally, the embodiment illustrated in FIG. 3 may also be used to reduce the risk of the presence of an air bubble 28 including when the optical fiber 10′ is prepared according to the embodiment shown in FIG. 2B. Moreover, the embodiment shown in FIG. 3 may be used even when the optical fiber 10′ is not so prepared to eliminate or reduce internal reflection of the signal 18.

Using one or more of the techniques illustrated in FIGS. 2B and 3, an attenuated splitter module with a low channel count, as a non-limiting example, 4 or 8 output channels, can be achieved by using splitters of higher channel counts, as non-limiting examples, 16 or 32 outputs channels. In this regard, only the output optical fibers for the required output channels are terminated with connectors. The remaining output optical fibers are cut and terminated in a way that internal reflections in the output optical fibers are eliminated.

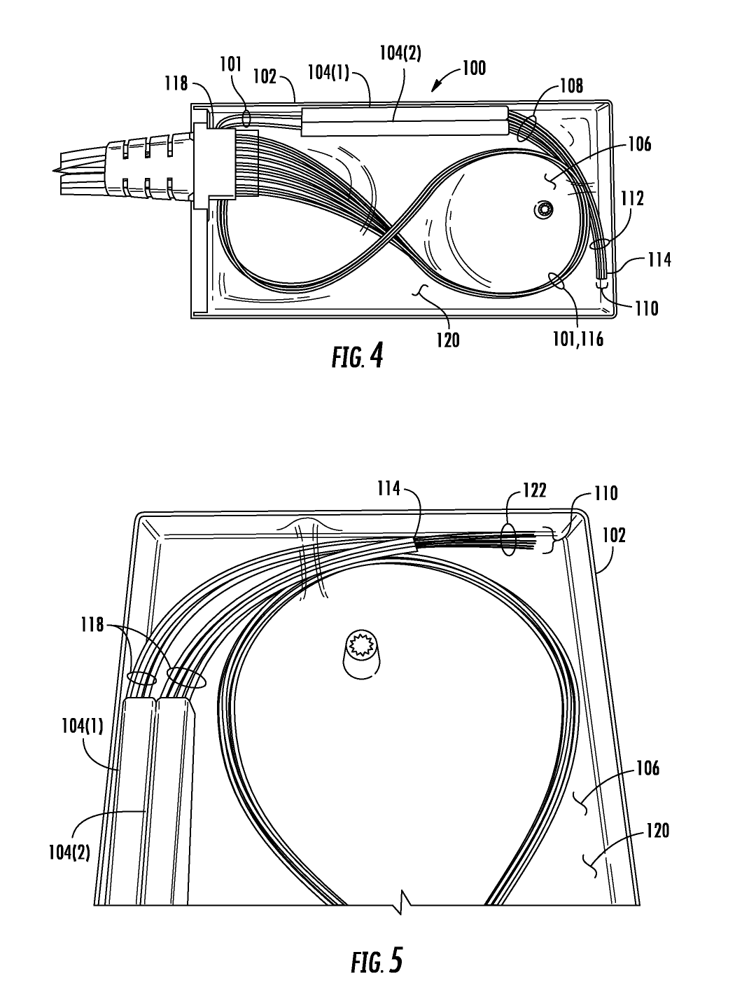

In this regard, FIGS. 4 and 5, illustrate embodiments of an optical splitter module 100 having a module housing 102 and optical splitter devices 104(1), 104(2), each of the splitter devices 104(1), 104(2) receiving an input fiber 101. Glass-index-matching material 106 is used to pot the splitter devices 104(1), 104(2) and at least one splitter leg 108 to secure the routing of the at least one splitter leg 108 in place in the module housing 102. The one or more splitter legs 108 include at least one first or cut optical fiber 112 and at least one second or channel count optical fiber 116. In the embodiments illustrated, the glass-index-matching material 106 serves an additional purpose. By matching the refractive index of the glass fiber of the cut optical fibers 112, the glass-index-matching material 106 prevents internal reflections of the optical signal 18 (not shown in FIGS. 4 and 5) at the interface 110 with glass fiber 122 of the cut optical fibers 112. For these optical fibers 112 the signal 18 continues to propagate and gets lost in the glass-index-matching material 106.

However, even with the cut optical fibers 112 being potted in the glass-index-matching material 106, an air bubble may still form at the end 110 of the glass fiber 122. To reduce or eliminate this possibility, the optical fiber 112, and thereby the glass fiber 122, may be cut long enough and the fiber coating 114 may be stripped off to expose the glass fiber 122 and embed the exposed glass fiber 122 in the glass-index-matching material 106. As a non-limiting example, such a cut may be, approximately 70 mm past the splitter. The coating 30 of the optical fiber 10 may be stripped off, for example without limitation, for the last 5 mm of the optical fiber 10. This protects against the possibility of an air bubble.

Additionally, and as discussed above with respect to FIG. 3, the glass fiber 122 may be cut at a 45-degree angle. Cutting the class fiber 122 at this angle will cause the signal 18 to reflect and be lost in the fiber cladding. While a precise 45-degree angle may be achieved by scoring the glass fiber 122 and applying a torque, this process may be time consuming and there may be times when the resulting end surface is not at 45 degrees. In such case, the potting of the optical fiber 112, and, thereby, the glass fiber 122, in the glass-index-matching material 106 allows for such imprecise cut of the end of the optical fiber 112. In this way, by doing one or more of exposing the optical fiber 112, and the glass fiber 122, past fiber coating 114, embedding the optical fiber 112 in the glass-index-matching material 106, and cutting the end of the glass fiber 122 at a 45 degree angle, internal reflection of the optical signal 18 may be reduced or eliminated.

Referring now to FIG. 4, there is shown a detail view of the interior 120 of an attenuated splitter module 100 with 2−1×4 splitter devices 104(1), 104(2). As such each splitter devices 104(1), 104(2) has four splitter legs 108, with each splitter leg having a first optical fiber 112 or a second optical fiber 116. As described above, the first optical fibers 112 are cut such that the glass fiber 122 is exposed when embedded in the glass-index-matching material 106 as the first optical fibers 112 are embedded in glass-index-matching material 106. If the first optical fibers 112 are in ribbon form, for ease of manufacturing the optical fibers 112 may be cut while they are still held together in ribbon form. Afterwards, the ribbon matrix is removed to allow the optical fibers 112 to be freely routed and secured inside the glass-index-matching material 106 potting compound. Removing the acrylic matrix from the fiber ribbon eliminates the possibility of localized twisting and bending that will degrade the long term performance of the splitter module 100. The at least one second or channel count optical fiber 116 are threaded through a fanout assembly 118 and potted in the module housing 102. The channel count optical fiber 116 extends out of the splitter module 100 and to other optical components (not shown in FIG. 4).

FIG. 5 is a detail partial view of the interior 120 of the attenuated splitter module 100 of FIG. 4 showing the at least one cut optical fiber 112. In FIG. 5, multiple cut optical fibers 112 are illustrated. As described above, the last few millimeters of the optical fibers 112 are cut and the fiber coating 114 stripped off to expose the glass fiber 122 which is embedded in the glass-index-matching material 106. In this manner, the chance of an air bubble forming is reduced.

Similar principles as described above are applicable in the assembly of attenuated splitter modules utilizing 1×N and 2×N devices. The same assembly method is also applicable in configurations with multiples of 1×N and 2×N devices (for example 2−1×4 or 2×4 or 2−2×4 etc).

Many modifications and other embodiments not set forth herein will come to mind to one skilled in the art to which the embodiments pertain having the benefit of the teachings presented in the foregoing descriptions and the associated drawings. Therefore, it is to be understood that the description and claims are not to be limited to the specific embodiments disclosed and that modifications and other embodiments are intended to be included within the scope of the appended claims. It is intended that the embodiments cover the modifications and variations of the embodiments provided they come within the scope of the appended claims and their equivalents. Although specific terms are employed herein, they are used in a generic and descriptive sense only and not for purposes of limitation.

What is claimed is:

1. An optical splitter module, comprising:
an enclosure;
a splitter device mounted in the enclosure and having at least one splitter leg, wherein the at least one splitter leg has a first optical fiber with a cut end, wherein the first optical fiber positions in an interior of the enclosure; and
glass-index-matching material at least partially filling the interior of the enclosure such the cut end of the optical fiber is embedded in the glass-index-matching material.

2. The optical splitter module of claim 1, wherein the glass-index-matching material is one of silicone, epoxy, and polyurethane.

3. The optical splitter module of claim 1, wherein the cut end of the first optical fiber forms an angle with a longitudinal axis of the optical fiber.

4. The optical splitter module of claim 3, wherein the angle is 45 degrees.

5. The optical splitter module of claim 1, wherein the optical fiber is cut such that the optical fibers extend for a length from the splitter to the cut end.

6. The optical splitter module of claim 5, wherein the length is up to 70 mm.

7. The optical splitter module of claim 5, wherein the length is at least about 70 mm.

8. The optical splitter module of claim 1, wherein a coating on the optical fiber is stripped off for a distance from a cut end.

9. The optical splitter module of claim 8, wherein the distance is up to about 5 mm.

10. The optical splitter module of claim 8, wherein the distance is at least about 5 mm.

11. The optical splitter module of claim 1, wherein the at least one splitter leg comprises a plurality of splitter legs.

12. The optical splitter module of claim 11, wherein ones of the plurality of splitter legs include one of a first optical fiber and a second optical fiber.

13. The optical splitter module of claim 12, wherein the second optical fiber is a channel count optical fiber and exits the splitter module.

14. The optical splitter module of claim 1, wherein the cut end of the first optical fiber is terminated in a bead of glass index-matching material.

15. A method of attenuating the optical signal in splitter output optical fibers, comprising:
disposing a splitter device in an optical splitter module enclosure;
routing at least one splitter leg having a first optical fiber from the splitter device in the optical splitter module;
cutting the first optical fiber such that the cut end positions with the enclosure; and
at least partially filling the enclosure with a glass-index-matching material such that the cut end is embedded in the glass-index-matching material.

16. The method of claim 15, wherein the cut end forms a 45 degree angle with a longitudinal axis of the first optical fiber.

17. The method of claim 15, further comprising extending the first optical fiber such that the first optical fiber extends a length of up to at least 70 mm from the splitter to the cut end.

18. The method of claim 15, further comprising extending the first optical fiber such that the first optical fiber extends a length of at least 70 mm from the splitter to the cut end.

19. The method of claim 15, further comprising stripping a coating from the first optical fiber a distance of up to at least 5 mm from the cut end.

20. The method of claim 15, further comprising stripping a coating from the first optical fiber a distance of at least 5 mm from the cut end.

21. The method of claim 15, wherein the at least one splitter leg comprises a plurality of splitter legs, and wherein ones of the plurality of splitter legs have one of a first optical fiber and a second optical fiber.

22. The method of claim 21, wherein the second optical fiber routes in the splitter module enclosure and is embedded in glass-index-matching material.

23. The method of claim 21, wherein the second optical fiber is a channel count optical fiber and exits the splitter module.

24. The method of claim 15, further comprising disposing a second splitter device in the splitter module enclosure.

25. The method of claim 24, wherein the second splitter device has a plurality of splitter legs, and wherein and wherein ones of the plurality of splitter legs have one of a first optical fiber and a second optical fiber.

26. The method of claim 15, further comprising cleaning the first optical fiber with solvent.
